(19) United States
(12) Patent Application Publication
(10) Pub. No.: US 2024/0304987 A1
(43) Pub. Date: Sep. 12, 2024

(54) ANTENNA WITH LOBE SHAPING

(71) Applicant: RADIO INNOVATION SWEDEN AB, Vällingby (SE)

(72) Inventors: Charlotta Andersson, Vällingby (SE); Daniel Skaufel, Vällingby (SE)

(21) Appl. No.: 18/575,132

(22) PCT Filed: Jun. 2, 2022
(86) PCT No.: PCT/EP2022/064999

§ 371 Date: Dec. 28, 2023

(30) Foreign Application Priority Data
Jul. 1, 2021 (SE) 2150863-5

(51) Int. Cl. H01Q 3/30; H01Q 1/24; H01Q 21/24; H01Q 21/29

(52) U.S. Cl. CPC H01Q 3/30; H01Q 1/246; H01Q 21/24; H01Q 21/29

(57) ABSTRACT

The present invention relates to an antenna (1) comprising at least one antenna panel (10), each comprising at least two groups (12a, 12b) of dipoles having a +45 degrees polarization and at least two groups (14a, 14b) of dipoles having a −45 degrees polarization, each group comprising at least one dipole, and two horizontal lobe shaping unit. HLSUs, (30a, 30b) wherein the groups of +45 degrees polarized dipoles are coupled to a first HLSLI, and the groups of −45 degrees polarized dipoles are coupled to a second HLSLI (30b).

### TECHNICAL FIELD

The present disclosure relates to an antenna, and especially to the construction of the antenna to provide an effective propagation of radio waves.

### BACKGROUND

The propagation characteristics of radio waves from an antenna defines the range of the antenna, and thereby the effectiveness of the antenna in reaching mobile communication units. In modern communication networks, such as 4G LTE, and 5G, the antennas capability in effectively reaching mobile communication units is of increasing importance. This further affects the capacity of the antenna and the base station to which the antenna may be connected, which is especially relevant in countryside and rural areas.

Further, when trying to increase the capacity of antennas, it is important that the solution is cost-effective, both in terms of the antenna's construction, but most important in terms of energy consumption since a low energy consumption may provide long term savings for the communication setup.

Following the above, there is a constant need in the telecommunication industry for 4G and 5G (as well as 2G and 3G) to provide an antenna that is cost-effective in terms of manufacturing and energy consumption, and at the same time provides a high gain and effective propagation.

### SUMMARY

It is an object of the present invention to provide an improved solution that alleviates the mentioned drawbacks with present devices. Furthermore, it is an object to provide an antenna that is energy efficient, and provides high gain and capacity. The invention is defined by the appended independent claims, with embodiments being set forth in the appended dependent claims, in the following description and in the drawings.

According to a first aspect of the present invention, an antenna is provided comprising at least one antenna panel, each comprising at least two groups of dipoles having a +45 degrees polarization and at least two groups of dipoles having a −45 degrees polarization, each group comprising at least one dipole, and two passive horizontal lobe shaping units, HLSUs, each comprising a directional coupler, wherein the groups of +45 degrees polarized dipoles are directly connected to a first HLSU, and the groups of −45 degrees polarized dipoles are directly connected to a second HLSU.

The antenna may comprise four groups of dipoles, two groups having a +45 degrees polarization, and two groups having a −45 degrees polarization. Each group of dipoles may comprise at least one dipole. The dipoles of the four groups may be coupled to the HLSUs at different terminals thereof. Each group of dipoles may generate a lobe to be propagated from the antenna. Without the HLSUs, the four lobes may provide a substantially similar propagation. The lobes may propagate in a three-dimensional space from the antenna. When in use, the lobes may be defined to propagate in a horizontal and vertical direction, as well as in a distance from the antenna.

A first group of +45 degrees polarized dipoles and a first group of −45 polarized dipoles may in an antenna panel be arranged in a common column. Similarly, a second group of +45 degrees polarized dipoles and a second group of −45 polarized dipoles may in an antenna panel be arranged in a common column. There may in embodiments be provided further numbers of groups of +45 and −45 degrees polarized dipoles, i.e. more than two groups of each, for instance three, four or five groups, or more groups. Such groups may thereby be provided in similar number of columns in each antenna panel.

Each group of dipoles may comprise one or more dipoles, for instance between 1 and 2, 4, 8, 16, 32, 64, 92, 128 or 256 dipoles in each group. The groups in each antenna panel of an antenna may in one embodiment comprise a common number of dipoles. The antenna may comprise two or more antenna panels. All antenna panels may in one embodiment be similar, with an common number of dipoles in each group.

The two HLSUs may be a passive electronic device to which the dipoles of the antenna panel(s) are directly connected. By directly connected it may be meant that each dipole is in unbroken electrical connection with a HLSU without other electrical components in between except the cable providing the electrical connection. The two HLSUs may shape the lobes in a horizontal direction such that the overlap between the lobes is reduced. The two HLSUs may also shape the lobes to propagate in different directions in the horizontal plane. This may be provided by the passive directional couplers of the HLSUs. All components of the antenna panels may be passive components.

The HLSUs may have different numbers of ingoing terminals for receiving signals from the antenna panel or panels. The number of ingoing terminals on the HLSUs may depend on the number of groups of dipoles in the antenna panels.

By using an antenna according to the present invention, a solution of a passive device is provided that is cost-efficient and with low energy consumption and high gain, and that is compatible with e.g. 2G, 3G, 4G, 5G, and MIMO ready up to MIMO 8. In some embodiments, the antenna may provide a gain of up to 30 dBi, compared to present standard antennas providing about 18 dBi. The solution of the present invention is suitable for all frequency bands (2300-2700 MHZ) in different applications, not only cellular telecom applications. In one embodiment, the antenna of the present invention may be a base station antenna. The antenna may further be a high-band lambda super system, HBLSS, antenna.

The antenna panels may be provided by a construction of aluminum or other suitable metal, to which the dipoles are arranged. An almost exclusive, or to the larger extent, use of aluminum in the antenna panels may contribute to low losses in the antenna of the present invention.

By coupling the dipoles of different polarization to separate HLSUs, the direction of the two lobes generated by the +45 degrees polarized dipoles may be separated from the direction of the two lobes generated by the −45 degrees polarized dipoles. The two groups of lobes may for instance be directed 180 degrees relative to each other in the horizontal plane.

In one embodiment, the HLSUs may be a directional coupler configured to shape the antenna lobe in a horizontal direction into two lobes.

The directional coupler of the two HLSUs may have contact terminals configured to receive signals from at least two dipoles of an antenna panel. The antenna may comprise two HLSUs. The directional couplers of the HLSUs may comprise contact terminals for signals from all +45 degrees polarized dipoles, or all −45 degrees polarized dipoles, of the antenna panel(s) of the antenna.

In one embodiment, the first HLSU may be configured to provide a 90 degrees phase shift between the signals from the two groups of +45 degrees polarized dipoles, and the second HLSU may be configured to provide a 90 degrees phase shift between the signals from the two groups of −45 degrees polarized dipoles.

By providing a 90 degrees phase shift between the signals from the dipoles, the lobes may be compressed and directed in the horizontal plane. By being compressed, the lobes may reach a longer distance from the antenna due to a gain increase of at least 3 dB compared to the uncompressed lobes. Further, by being directed, the lobes may be directed in different directions to provide a desired coverage. Each polarization of dipoles, e.g. the two groups of +45 degrees polarized dipoles or the two groups of −45 degrees polarized dipoles, may provide two lobes, which when phase shifted by the HLSU extend in different directions in the horizontal plane. The different directions may be provided by the two lobes extending with an angle relative to each other in the horizontal plane. Such angle may be 10-60 degrees. In another embodiment, said angle may be 30-50 degrees. In another embodiment, the angles may be about 40 degrees. A greater coverage with compressed lobes may be provided by shaping the lobes with an angle relative each other.

In one embodiment, the first HLSU may be configured to shape the lobes generated by the +45 degrees polarized dipoles such that they may be directed with an angle relative each other in a horizontal plane, and the second HLSU may be configured to shape the lobes generated by the −45 degrees polarized dipoles such that they may be directed with an angle relative each other in a horizontal plane, wherein said angles may be 10-60 degrees.

In one embodiment, the panel may further comprise at least four vertical lobe shaping units, VLSU, wherein the VLSUs may be arranged between the at least one antenna panel and the two HLSUs. One group of +45 degrees polarized dipoles of each antenna panel may be coupled to a first VLSU, and another group of +45 degrees polarized dipoles of each antenna panel may be coupled to a third VLSU, and the first VLSU and the third VLSU may be coupled to the first HLSU. Further, one group of −45 degrees polarized dipoles of each antenna panel may be coupled to a second VLSU, and another group of −45 degrees polarized dipoles of each antenna panel may be coupled to a fourth VLSU, and the second VLSU and the fourth VLSU may be coupled to the second HLSU.

The VLSUs may be provided to shape the lobes generated by the dipoles in a vertical direction. The two groups of each polarization of each antenna panel may thereby be shaped differently in the vertical direction by means of the two VLSUs for each polarization, but commonly shaped in the horizontal direction by means of the HLSU common for all dipoles of each polarization. Especially when two or more antenna panels are stacked on top of each other in the vertical direction, such embodiment may enable beneficial desired lobe shapes.

In one embodiment, the VLSU may be a splitter, combiner and/or amplitude-and phase distributor configured to shape the antenna lobe in a vertical direction. The VLSU may thereby comprise components of a feeding circuit to which the output of the dipoles of the different groups are coupled. The VLSU may have the purpose of shaping the lobes by distributing phase and amplitude of the incoming signals from the dipoles differently between the outgoing terminals of the VLSU. Hence, the amplitude and phase of the outgoing terminals of the VLSU may in one embodiment not be equal. The VLSU or VLSUs may have different numbers of ingoing and outgoing terminals depending on the number of antenna panels. The difference in amplitude between different outgoing terminals of the VLSU may be provided by adjustment of the width of the conductors between the terminals. The difference in phase between different outgoing terminals of the VLSU may be provided by adjustment of the length of the conductors between the terminals.

The antenna may comprise at least two antenna panels stacked on top of each other in a vertical direction. Alternatively, the antenna may comprise at least four antenna panels stacked on top of each other in a vertical direction. When using two or four antenna panels stacked in the vertical direction, the common VLSUs may provide a common lobe shape in the vertical direction for the dipoles of all antenna panels, and the common HLSUs for the dipoles of different polarization may provide a common horizontal lobe shape for all antenna panels. The effectiveness of the lobes in terms of gain and direction may thereby be improved, thereby providing a more efficient antenna. By vertical direction it may be meant a direction vertical relative to a ground surface onto which the antenna is, or is intended to be, arranged.

The couplings between antenna panels and the HLSU and/or VLSU in any of the embodiments above may be provided by coaxial cables.

### BRIEF DESCRIPTION OF THE DRAWINGS

The invention will in the following be described in more detail with reference to the enclosed drawings, wherein:

FIGS. 1a-c show block schemes of antennas according to embodiments of the present invention;

FIG. 2 shows a block scheme of an antenna according to an embodiment of the present invention;

FIGS. 3a-b show block schemes of antennas according to embodiments of the present invention;

FIG. 4a shows a schematic view of an antenna panel without lobe shaping; and

FIG. 4b shows a schematic view of an antenna panel with lobe shaping according to an embodiment of the present invention.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

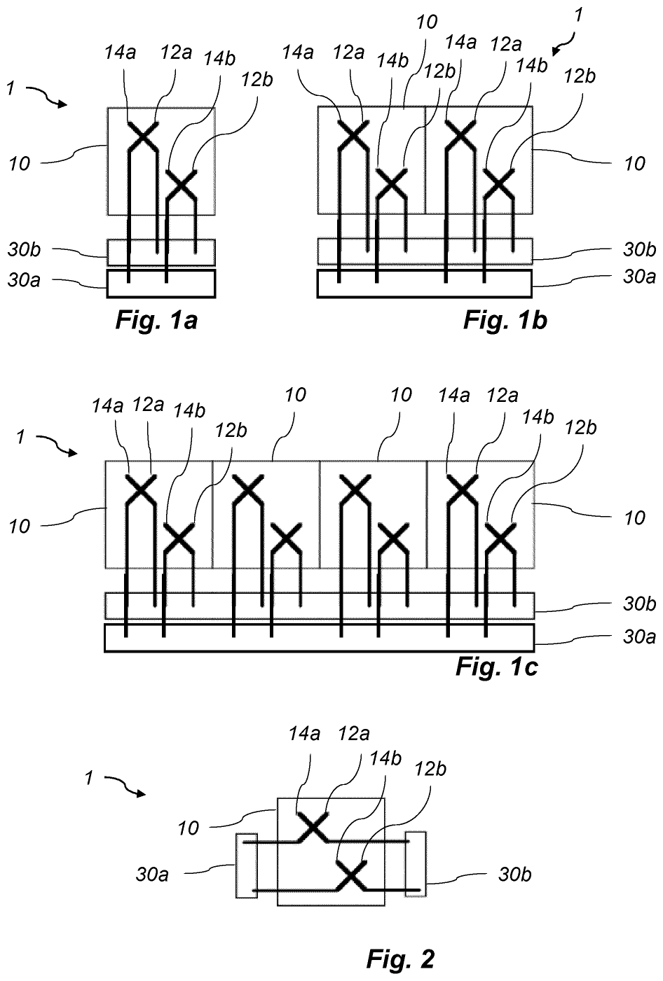

FIGS. 1a-c illustrate antennas 1 according to embodiments of the present invention with different numbers of antenna panels 10. In FIG. 1a, an antenna 1 with one antenna panel 10 is shown. The antenna panel 10 comprises two groups of +45 degrees polarized dipoles 12a, 12b, and two groups of −45 degrees polarized dipoles 14a, 14b. Each group of dipoles comprises in the illustrated embodiment one dipole. Alternatively, each group of dipoles, in any of the embodiments described herein, may comprise between 1-256 dipoles, such as 92 dipoles. The dipoles from each group are coupled to a horizontal lobe shaping unit, HLSU, 30a, 30b providing a shaping of the lobes generated by the dipoles in the horizontal direction. The two groups of +45 degrees polarized dipoles 12a, 12b are coupled to a first HLSU 30a, and the two groups of −45 degrees polarized dipoles 14a, 14b are coupled to a second HLSU 30b. When in use, the antenna 1 is arranged such that the dipoles of the antenna panels 10 generate lobes propagating in a direction away from the antenna panel, and with a horizontal and vertical extension. The HLSUs 30a, 30b are configured to shape the lobes in the horizontal direction.

FIG. 1b illustrates an embodiment of the antenna 1 comprising two antenna panels 10, each comprising two groups of +45 degrees polarized dipoles 12a, 12b, and two groups of −45 degrees polarized dipoles 14a, 14b. The different polarized dipoles of the antenna panels 10 are coupled to respective HLSUs 30a, 30b. The two groups of +45 degrees polarized dipoles 12a, 12b are coupled to a first HLSU 30a, and the two groups of −45 degrees polarized dipoles 14a, 14b are coupled to a second HLSU 30b. The two antenna panels 10 are arranged next to each other in the horizontal plane. The HLSUs 30a, 30b thereby shapes each lobe generated by the dipoles in the antenna panels 10 in a horizontal direction. The HLSUs 30a, 30b may shape the generated lobes in two, three or four different horizontal directions.

FIG. 1c illustrates a similar embodiment of an antenna 1 comprising four antenna panels 10 arranged next to each other in the horizontal plane. Each antenna panel 10 comprises two groups of +45 degrees polarized dipoles 12a, 12b, and two groups of −45 degrees polarized dipoles 14a, 14b. All groups of +45 degrees polarized dipoles 12a, 12b of the antenna panels 10 are coupled to the first HLSU 30a, and all groups of −45 degrees polarized dipoles 14a, 14b of the antenna panels 10 are coupled to the second HLSU 30b. The HLSUs 30a, 30b thereby shapes each lobe generated by the dipoles in the antenna panels 10 in a horizontal direction. The HLSUs 30a, 30b may shape the generated lobes from the four antenna panels 10 in up to eight different horizontal directions.

FIG. 2 illustrates an embodiment of an antenna 1 comprising one antenna panel and two HLSUs 30a, 30b, wherein the two HLSUs 30a, 30b are arranged to provide a shaping of the generated lobes in different horizontal directions.

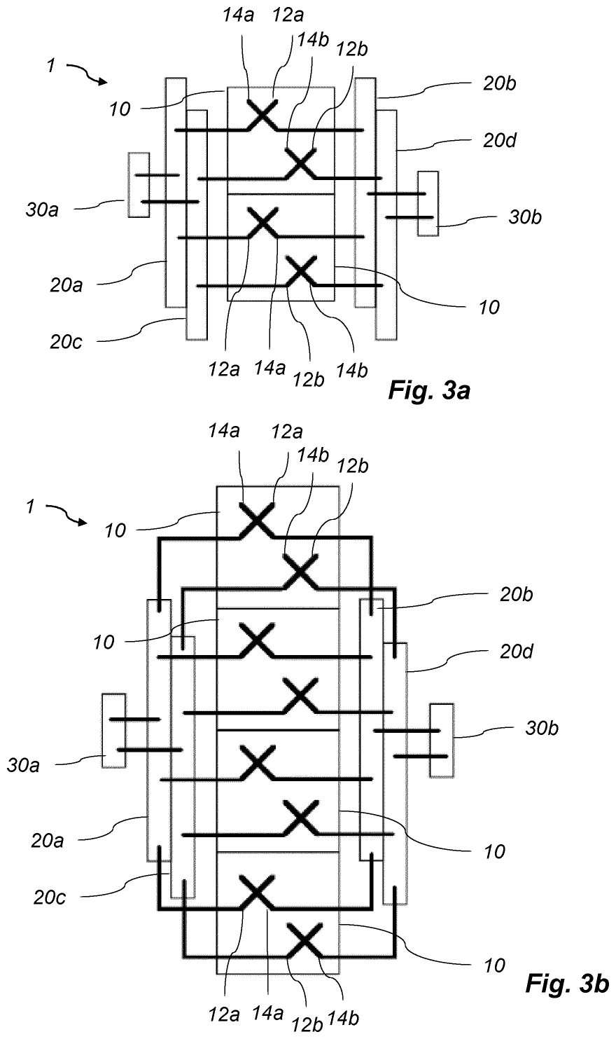

FIGS. 3a and 3b illustrate embodiments of antennas 1 comprising two or four antenna panels 10 arranged next to each other in the vertical direction. Each antenna panel 10 comprises two groups of +45 degrees polarized dipoles 12a, 12b, and two groups of −45 degrees polarized dipoles 14a, 14b. The antenna 1 further comprises four vertical lobe shaping units, VLSUs, 20a-d.

The dipoles of a first group of +45 degrees polarized dipoles 12a in each antenna panel 10 are coupled to the first VLSU 20a. The dipoles of a second group of +45 degrees polarized dipoles 12b in each antenna panel 10 are coupled to the third VLSU 20b. The dipoles of a first group of −45 degrees polarized dipoles 14a in each antenna panel 10 are coupled to the second VLSU 20b. The dipoles of a second group of −45 degrees polarized dipoles 14b in each antenna panel 10 are coupled to the fourth VLSU 20b.

The first VLSU 20a and the third VLSU 20c, i.e. the VLSUs to which the dipoles of the groups of +45 degrees polarized dipoles are coupled, are coupled to the first HLSU 30a. The second VLSU 20b and the fourth VLSU 20d, i.e. the VLSUs to which the dipoles of the groups of −45 degrees polarized dipoles are coupled, are coupled to the second HLSU 30b.

Provided such arrangement, the VLSUs 20a-d shape the lobes of the different groups of dipoles 12a-b, 14a-b in the vertical direction. Thereafter, the HLSUs 30a-b shape the vertically shaped lobes in the horizontal direction.

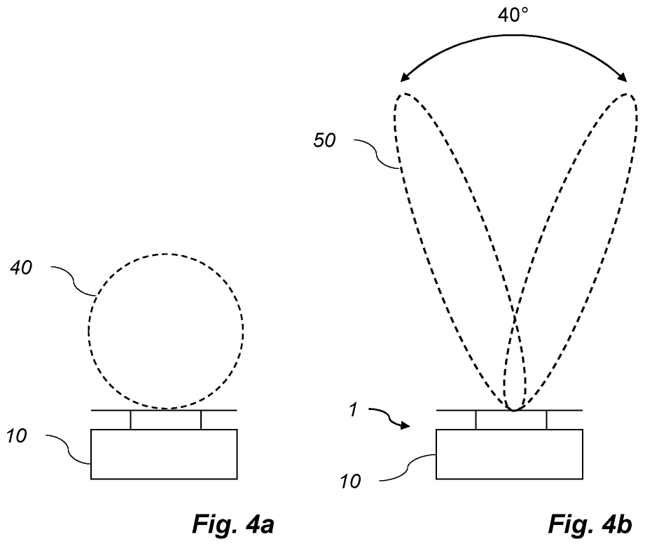

FIG. 4a illustrates an antenna panel 10 with two groups of each polarization of dipoles, without any lobe shaping unit. The lobes 40 generally generated by such antenna panel 10 coincide in a common propagation substantially uniform in the horizontal and vertical directions. To increase the energy efficiency and propagation of the lobes, at least a HLSU may be used.

In FIG. 4b, an embodiment is illustrated of an antenna 1 comprising an antenna panel 10 having two groups of each polarization of dipoles 12a-b, 14a-b. Each group 12a-b, 14a-b comprises in the illustrated embodiment four dipoles. The antenna panel 10 is schematically illustrated from above in a normal orientation of use. A HLSU 30 shapes the lobes 50 in the horizontal direction. The HLSU 30 provides a phase shift of 90 degrees between the groups of the same polarization, which makes the lobe narrower in the horizontal direction. Since the same energy is present in the lobe, the propagation of the lobe will be longer. At the same time, the lobes of the two polarizations are turned 20 degrees in respective directions, providing 40 degrees angle between the two resulting lobes in the horizontal plane.

A shaping of the lobes in the horizontal plane to narrower lobes may provide a gain increase of about 3 dB compared to the unshaped lobes, for each antenna panel 10 in the antenna 1. Hence, with two, four or more antenna panels 10 stacked in the vertical direction, the gain increase may be double, quadruple etc. compared to a standard unshaped lobe.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. An antenna characterized in comprising
at least one antenna panel, each comprising at least two groups of dipoles having a +45 degrees polarization and at least two groups of dipoles having a −45 degrees polarization, each group comprising at least one dipole,
two passive horizontal lobe shaping units, HLSUs, each comprising a directional coupler,
wherein the groups of +45 degrees polarized dipoles are directly connected to a first HLSU and the groups of −45 degrees polarized dipoles are directly connected to a second HLSU,
wherein the first HLSUs is configured to provide a 90 degrees phase shift between the signals from the two groups of +45 degrees polarized dipoles, and the second HLSU is configured to provide a 90 degrees phase shift between the signals from the two groups of −45 degrees polarized dipoles.

2. The antenna according to claim 1, wherein the HLSUs are directional couplers configured to shape the antenna lobe in a horizontal direction into two lobes.

3. The antenna according to claim 1, wherein the first HLSU is configured to shape the lobes generated by the +45 degrees polarized dipoles such that they are directed with an angle relative each other in a horizontal plane, and the second HLSU is configured to shape the lobes generated by the −45 degrees polarized dipoles such that they are directed with an angle relative each other in a horizontal plane, wherein said angles are 10-60 degrees.

4. The antenna according to claim 1, wherein the antenna further comprises at least four vertical lobe shaping units, VLSU, wherein the VLSUs are arranged between the at least one antenna panel and the two HLSUs,
wherein one group of +45 degrees polarized dipoles of each antenna panel is coupled to a first VLSU, and another group of +45 degrees polarized dipoles of each antenna panel is coupled to a third VLSU, and wherein the first VLSU and the third VLSU are coupled to the first HLSU, and
wherein one group of −45 degrees polarized dipoles of each antenna panel is coupled to a second VLSU, and another group of −45 degrees polarized dipoles of each antenna panel is coupled to a fourth VLSU, and wherein the second VLSU and the fourth VLSU are coupled to the second HLSU.

5. The antenna according to claim 4, wherein each VLSU is a splitter, combiner and/or amplitude-and phase distributor configured to shape the antenna lobe in a vertical direction.

6. The antenna according to claim 1, wherein the antenna comprises at least two antenna panels stacked on top of each other in a vertical direction.

7. The antenna according to claim 1, wherein the antenna comprises at least four antenna panels stacked on top of each other in a vertical direction.

8. The antenna according to claim 3, wherein said angles are 30-50 degrees.

9. The antenna according to claim 3, wherein said angles are about 40 degrees.
